(19) United States
(12) Patent Application Publication
(10) Pub. No.: US 2021/0111435 A1
(43) Pub. Date: Apr. 15, 2021

(54) ELECTRODE SHEET, ALL-SOLID BATTERY, METHOD FOR MANUFACTURING ELECTRODE SHEET, AND METHOD FOR MANUFACTURING ALL-SOLID BATTERY

(71) Applicant: KURASHIKI BOSEKI KABUSHIKI KAISHA, Okayama (JP)

(72) Inventor: Noboru HIGASHI, Osaka (JP)

(73) Assignee: KURASHIKI BOSEKI KABUSHIKI KAISHA, Okayama (JP)

(21) Appl. No.: 16/498,377

(22) PCT Filed: Mar. 20, 2018
(86) PCT No.: PCT/JP2018/011034

§ 371 Date: Sep. 26, 2019

(30) Foreign Application Priority Data
Mar. 31, 2017 (JP) 2017-070295

(51) Int. Cl. H01M 10/0585; H01M 10/056; H01M 10/0525; H01M 4/139; H01M 4/04; H01M 4/62

(52) U.S. Cl. CPC H01M 10/0585; H01M 10/056; H01M 4/62; H01M 4/139; H01M 4/0404; H01M 10/0525

(57) ABSTRACT

An electrode sheet usable for an all-solid battery in which a polymer solid electrolyte is used, internal resistance is low, and an internal short-circuit hardly occurs. An electrode sheet 10 includes: a current collector 11; an electrode 12 formed on the current collector and containing active material particles 13 and a polymer solid electrolyte 14 filling gaps between the active material particles; and a separator layer 15 formed on the electrode and containing inorganic solid electrolyte particles 16 and the polymer solid electrolyte 14 filling gaps between the inorganic solid electrolyte particles.

### TECHNICAL FIELD

The present invention relates to an electrode sheet containing an inorganic solid electrolyte and a polymer solid electrolyte, and a method for manufacturing the electrode sheet. The present invention also relates to an all-solid battery containing an inorganic solid electrolyte and a polymer solid electrolyte, and a method for manufacturing the all-solid battery.

### BACKGROUND ART

Development of a solid lithium ion secondary battery containing a solid electrolyte in place of a liquid electrolytic solution has been extensively conducted. When a solid electrolyte is used, it is possible to make batteries thinner and obtain such an outstanding characteristic that leakage of an electrolytic solution does not occur. As such solid electrolytes, inorganic solid electrolytes, polymer solid electrolytes, and polymer gel-like electrolytes are known.

In recent years, inorganic solid electrolytes excellent in ion conductivity have been developed. However, there is the problem that an inorganic solid electrolyte is in the form of particles, and therefore in a poor state of contact with active material particles, so that the internal resistance of a battery increases, leading to a decrease in battery capacity.

The polymer gel-like electrolyte is a gel-like solid electrolyte in which an organic solvent containing an electrolyte salt is held in a polymer network. It has been suggested that gaps between active material particles which form an electrode are impregnated with a polymer gel-like electrolyte to improve the state of contact of a solid electrolyte with the active material particles. Patent Literature 1 discloses a polymer (gel-like) solid electrolyte battery obtained by applying a monomer composition to a surface of a positive active material layer to impregnate the positive active material layer with part of the monomer composition, and then subjecting the monomer composition to thermal polymerization. Further, Patent Literature 2 discloses a solid electrolyte battery in which adhesiveness at a bonding interface between a solid electrolyte and an active material is improved by impregnating an active material layer with a solid electrolyte solution with a gel-like polymer solid electrolyte dissolved in a solvent.

### CITATION LIST

### Patent Literature

Patent Literature 1: JP H7-326383 A

Patent Literature 2: JP H11-195433 A

### SUMMARY OF INVENTION

### Technical Problem

However, a solid electrolyte layer including a polymer gel-like electrolyte has the problem that the layer has low strength. Thus, particularly when such a solid electrolyte layer is used for a film-shaped battery having flexibility, a separator layer separating both electrodes from each other may be broken by deformation of the battery, leading to occurrence of an internal short-circuit. Further, when the content of the organic solvent is made excessively high for increasing the mobility of an electrolyte salt in a polymer gel-like electrolyte, there remains the problem of liquid leakage. Further, the method in which an active material layer is impregnated with a polymer gel-like electrolyte has the problem that it takes much time for impregnation of the solution, or it is difficult to infiltrate the solution throughout the active material layer.

On the other hand, a polymer solid electrolyte may be used for enhancement of the strength and durability of a separator layer. The polymer solid electrolyte is a solid electrolyte containing an electrolyte salt in a polymer. However, in the polymer solid electrolyte, the mobility of the electrolyte salt in the solid polymer is low. Thus, when the separator layer is excessively thick, there is the problem that the internal resistance of the battery increases, so that practical charge-discharge characteristics cannot be obtained. On the other hand, when the separator layer is excessively thin, even a polymer solid electrolyte cannot eliminate the possibility that the separator layer is broken by, for example, repeated bending deformation of the battery, and an internal short-circuit occurs.

The present invention has been made in view of the above circumstances, and an object of the present invention is to provide an all-solid battery in which a polymer solid electrolyte is used, internal resistance is low, and an internal short-circuit hardly occurs; and an electrode sheet usable for the all-solid battery.

### Solution to Problem

In an electrode sheet and an all-solid battery of the present invention, for achieving the above-described object, inorganic solid electrolyte particles and a polymer solid electrolyte are contained in a separator layer to ensure that the separator layer has both ion conductivity and strength.

Specifically, the electrode sheet of the present invention includes: a current collector; an electrode formed on the current collector and containing active material particles and a polymer solid electrolyte filling gaps between the active material particles; and a separator layer formed on the electrode and containing inorganic solid electrolyte particles and the polymer solid electrolyte filling gaps between the inorganic solid electrolyte particles.

By using this electrode sheet, an all-solid battery can be manufactured in which there is no risk of liquid leakage, internal resistance is low, and an internal short-circuit hardly occurs.

Preferably, the polymer solid electrolyte contained in the electrode and the polymer solid electrolyte contained in the separator layer are integrally formed. This configuration ensures that interface resistance between the electrode and the separator layer can be decreased.

Preferably, the electrode further contains second inorganic solid electrolyte particles. This improves the mobility of charge moving through gaps between active material particles, so that the internal resistance of the electrode further decreases.

The all-solid battery of the present invention is formed by laminating a positive electrode current collector; a positive electrode containing positive active material particles and a positive electrode polymer solid electrolyte filling gaps between the positive active material particles; a separator layer containing inorganic solid electrolyte particles and a separator layer polymer solid electrolyte filling gaps between the inorganic solid electrolyte particles; a negative electrode containing negative active material particles and a negative electrode polymer solid electrolyte filling gaps between the negative active material particles; and a negative electrode current collector, in this order.

Preferably, the positive electrode polymer solid electrolyte and/or the negative electrode polymer solid electrolyte is formed integrally with the separator layer polymer solid electrolyte at a portion which is in contact with the positive electrode polymer solid electrolyte or the negative electrode polymer solid electrolyte.

Preferably, the positive electrode and/or the negative electrode further contains second inorganic solid electrolyte particles.

A method for manufacturing an electrode sheet according to the present invention includes: a step of preparing a current collector; a step of forming an active material layer on the current collector by applying an electrode composite containing active material particles; a step of forming an inorganic solid electrolyte layer containing inorganic solid electrolyte particles on the active material layer; a solution supplying step of supplying a polymer solid electrolyte solution to infiltrate the polymer solid electrolyte solution into the active material layer and the inorganic solid electrolyte layer, the polymer solid electrolyte solution containing a polymer compound and an alkali metal salt; and a curing step of forming a polymer solid electrolyte between the active material particles and between the inorganic solid electrolyte particles by polymerizing the polymer compound after the solution supplying step.

Here, the polymer solid electrolyte solution is a raw material solution for forming a polymer solid electrolyte, and a polymer compound in the polymer solid electrolyte solution is polymerized to form the polymer solid electrolyte. Further, polymerization of a polymer compound includes crosslinking the polymer compound with a crosslinking agent. With this method, the polymer solid electrolyte solution is formed after the polymer solid electrolyte solution permeates the inorganic solid electrolyte layer, the interface between the inorganic solid electrolyte layer and the active material layer, and the active material layer, and therefore a favorable state of contact of the polymer solid electrolyte is obtained over the entire electrode sheet.

Preferably, the solution supplying step includes the following two steps of: supplying the polymer solid electrolyte solution onto the active material layer to infiltrate the polymer solid electrolyte solution into the active material layer after forming the active material layer; and supplying the polymer solid electrolyte solution onto the inorganic solid electrolyte layer to infiltrate the polymer solid electrolyte solution into the inorganic solid electrolyte layer after forming the inorganic solid electrolyte layer. With this method, the polymer solid electrolyte solution is integrally formed after the polymer solid electrolyte solution permeates the inorganic solid electrolyte layer, the interface between the inorganic solid electrolyte layer and the active material layer, and the active material layer, and therefore a favorable state of contact of the polymer solid electrolyte is obtained over the entire electrode sheet.

Preferably, the solution supplying step is a step of supplying the polymer solid electrolyte solution by a noncontact coating method. Here, the noncontact coating method is a method in which a solution is supplied without bringing a member such as a roll or a nozzle into contact with a surface of an inorganic solid electrolyte layer. This ensures that the polymer solid electrolyte solution can be supplied without damaging the inorganic solid electrolyte layer and the active material layer.

Preferably, the electrode composite further contains second inorganic solid electrolyte particles.

A method for manufacturing an all-solid battery according to the present invention includes: a step of manufacturing a first electrode sheet by one of the above methods; a step of manufacturing a second electrode sheet opposite in polarity to the first electrode sheet by one of the above methods; and a bonding step of bonding the first electrode sheet and the second electrode sheet to each other in such a manner that the current collector of the first electrode sheet and the current collector of the second electrode sheet form the outermost surface. Here, the first electrode sheet may be either a positive electrode sheet or a negative electrode sheet.

Another method for manufacturing an all-solid battery according to the present invention includes: a step of manufacturing a first electrode sheet by one of the above methods; and a step of manufacturing a second electrode sheet opposite in polarity to the first electrode sheet. The step of manufacturing the second electrode sheet includes: a step of preparing a second current collector; a step of forming a second active material layer containing second active material particles on the second current collector; a second solution supplying step of supplying a second polymer solid electrolyte solution onto the second active material layer to infiltrate the second polymer solid electrolyte solution into the second active material layer, the second polymer solid electrolyte solution containing a second polymer compound and the alkali metal salt; and a second curing step of forming a second polymer solid electrolyte between the second active material particles by polymerizing the second polymer compound. The method further includes a bonding step of bonding the first electrode sheet and the second electrode sheet to each other in such a manner that the current collector of the first electrode sheet and the second current collector of the second electrode sheet form the outermost surface.

### Advantageous Effects of Invention

According to the electrode sheet or the all-solid battery of the present invention, there is no risk of liquid leakage because the electrolyte is formed of an inorganic solid electrolyte and a polymer solid electrolyte. Further, since the polymer solid electrolyte fills gaps between active material particles, the polymer solid electrolyte is in a favorable state of contact with the active material particles, so that the internal resistance of the electrode is kept low. Further, since the separator layer can contain an inorganic solid electrolyte having a higher electrolyte salt mobility and lithium ion transport number as compared to a polymer solid electrolyte, the internal resistance of a battery can be decreased to improve charge-discharge characteristics. Further, since the separator layer contains inorganic solid electrolyte particles having a hardness higher than that of a polymer solid electrolyte, the separator layer is hardly broken by repeated bending deformation of the battery or the like, so that an internal short-circuit hardly occurs. In addition, since the separator layer can be formed with a small thickness, the internal resistance of the battery can be decreased to improve charge-discharge characteristics.

According to the method for manufacturing an electrode sheet and the method for manufacturing an all-solid battery according to the present invention, a polymer solid electrolyte solution having a low viscosity is infiltrated into gaps between active material particles and gaps between inorganic solid electrolyte particles, and then polymerized to form a polymer solid electrolyte, and therefore it is easy to infiltrate the polymer solid electrolyte solution into the active material layer and the inorganic solid electrolyte layer extensively. Consequently, a battery having a polymer solid electrolyte in a favorable state of contact with active material particles and having low internal resistance can be obtained. Further, since the polymer solid electrolyte in at least one of the electrodes is formed integrally with the polymer solid electrolyte in the separator layer, a battery having reduced interface resistance and low internal resistance can be obtained.

### BRIEF DESCRIPTION OF DRAWINGS

FIG. 1 is a view schematically showing a structure of an electrode sheet according to a first embodiment of the present invention.

FIG. 2 is a process flow diagram of a method for manufacturing an electrode sheet according to the first embodiment of the present invention.

FIG. 3 is a view schematically showing a structure of an electrode sheet according to a second embodiment of the present invention.

FIG. 4 is a process flow diagram of a method for manufacturing an electrode sheet according to the second embodiment of the present invention.

FIG. 5 is a view schematically showing a structure of an all-solid battery according to a third embodiment of the present invention.

FIG. 6 is a process flow diagram of a method for manufacturing an all-solid battery according to the third embodiment of the present invention.

FIG. 7 is a view schematically showing a structure of an all-solid battery according to a fourth embodiment of the present invention.

FIG. 8 is a view schematically showing a structure of a negative electrode sheet used for manufacturing the all-solid battery according to the fourth embodiment of the present invention.

FIG. 9 is a process flow diagram of a method for manufacturing an all-solid battery according to the fourth embodiment of the present invention.

FIG. 10 shows the results of a charge-discharge test of an evaluation battery containing a positive electrode sheet of Comparative Example 1.

FIG. 11 shows the results of a charge-discharge test of an evaluation battery containing a positive electrode sheet of Comparative Example 2.

FIG. 12 shows the results of a charge-discharge test of an evaluation battery containing a negative electrode sheet of Comparative Example 3.

FIG. 13 shows the results of a charge-discharge test of an evaluation battery containing a positive electrode sheet of Example 1.

FIG. 14 shows the results of a charge-discharge test of an evaluation battery containing a positive electrode sheet of Comparative Example 4.

FIG. 15 shows the results of a charge-discharge test of an all-solid battery of Example 2.

FIG. 16 is a process flow diagram of a modification of the method for manufacturing an electrode sheet according to the first embodiment of the present invention.

### DESCRIPTION OF EMBODIMENTS

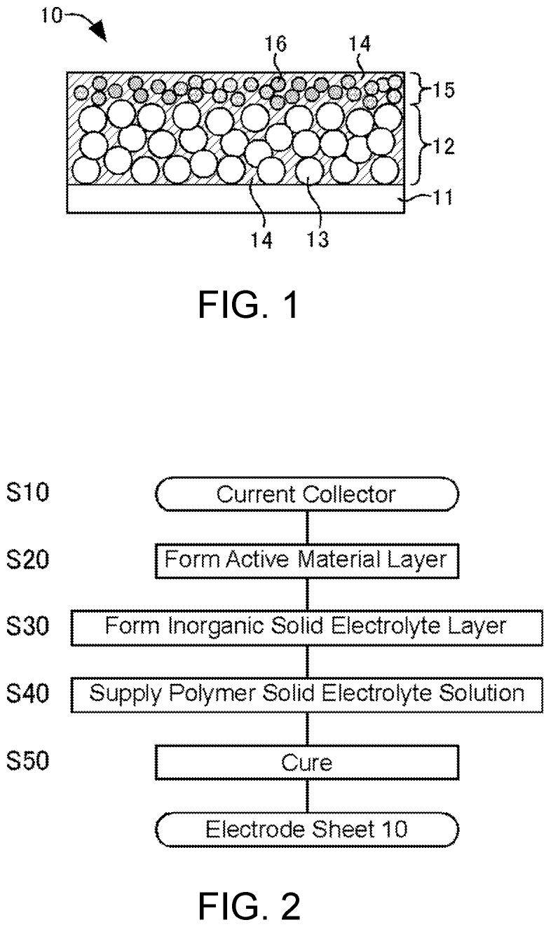

As a first embodiment of the present invention, an electrode sheet for an all-solid lithium ion battery will be described with reference to FIGS. 1 and 2.

In FIG. 1, an electrode sheet 10 of this embodiment is formed by laminating a current collector 11, an electrode 12 and a separator layer 15 in this order. The electrode sheet 10 is a positive electrode sheet or a negative electrode sheet. When the electrode sheet 10 is a positive electrode sheet, the electrode sheet 10 includes a positive electrode current collector, a positive electrode and a separator layer, and when the electrode sheet 10 is a negative electrode sheet, the electrode sheet 10 includes a negative electrode current collector, a negative electrode and a separator layer.

For the current collector 11, various materials having electron conductivity can be used. For the positive electrode current collector, for example, a foil of aluminum, titanium or stainless steel can be used, and it is preferable to use a foil of aluminum which is excellent in oxidation resistance. The thickness of the aluminum foil is preferably 5 to 25 μm. As the negative electrode current collector, for example, a foil of copper, nickel, aluminum or iron can be used, and it is preferable to use a copper foil which is stable in a reduction field and excellent in electroconductivity. The thickness of the copper foil is preferably 5 to 15 μm. Further, such a metal film laminated to a resin film may be used. In this case, strength required for handling can be given by the resin film, and therefore the metal foil may have a thickness smaller than that of a metal foil which is used alone. The thickness of the laminated metal foil and resin film is preferably 20 to 50 μm.

The electrode 12 contains active material particles 13 as a main component, and as necessary, contains additive components such as a conductive additive, a binder and a filler. Further, a polymer solid electrolyte 14 fills gaps between the active material particles. Preferably, the polymer solid electrolyte 14 fills gaps between active material particles throughout the electrode 12 over the entire region from the surface of the current collector to an interface with the separator layer.

As the positive active material 13, a well-known material, which absorbs and desorbs Li ions, such as LiCoO₂ or LiNiO₂, can be used. As the conductive additive, a known electron conductive material such as acetylene black, ketjen black, other carbon black, metal powder or an electroconductive ceramic material can be used. The amount of the conductive additive added is typically several percent by weight based on the positive active material. As the binder, a known material such as polytetrafluoroethylene (PTFE) or polyvinylidene fluoride (PVdF) can be used. Further, a material having ion conductivity can be used as the binder. As the binder having ion conductivity, for example, an ion-conductive binder containing a polymer electrolyte composition obtained by graft-polymerizing a skeleton of an ion liquid with a fluorine-based polymer such as PVdF is disclosed in JP 2015-038870 A. It is also possible to use, as a binder, another well-known lithium ion-conductive polymer matrix in which a Li metal salt is held in an ether-based polymer such as polyethylene oxide or polyethylene oxide. The amount of the binder added is typically several percent by weight based on the positive active material. As the filler, a well-known material such as an olefin-based polymer such as polypropylene, or zeolite can be used. The amount of the filler added is typically zero to several percent by weight based on the positive active material.

The thickness of the positive electrode 12 is preferably 5 to 30 μm, more preferably 10 to 20 μm. When the positive electrode is excessively thin, a sufficient battery capacity cannot be obtained. Further, when the positive electrode is excessively thick, a battery completed has a large thickness, and the distance over which Li ions move in the polymer solid electrolyte in the positive electrode increases, so that the charge and discharge rate decreases. Further, it is difficult to infiltrate the polymer solid electrolyte solution homogeneously into the positive electrode, and voids are easily generated in the positive electrode.

As the negative active material 13, a well-known material, which absorbs and desorbs Li ions, such as graphite or coke, can be used. The same conductive additive, binder and filler as those added to the positive active material can be added to the negative active material.

The thickness of the negative electrode 12 is preferably 5 to 30 μm, more preferably 10 to 20 μm. When the negative electrode is excessively thin, a sufficient battery capacity cannot be obtained. Further, when the negative electrode is excessively thick, a battery completed has a large thickness, and the distance over which Li ions move in the polymer solid electrolyte in the negative electrode increases, so that the charge and discharge rate decreases. Further, it is difficult to infiltrate the polymer solid electrolyte solution homogeneously into the negative electrode, and voids are easily generated in the negative electrode.

It is desirable that the polymer solid electrolyte 14 between the active material particles 13 of the electrode 12 fill gaps between active material particles throughout the electrode over the entire region from the surface of the current collector 11 to the interface with the separator layer 15.

The polymer solid electrolyte 14 contains an electrolyte salt in a polymer. As the polymer, polyethylene oxide (PEO), polypropylene oxide (PPO), a copolymers thereof, or the like can be used. Preferably, the polymer molecules are crosslinked, or other polymers or oligomers are graft-polymerized with the main skeleton of the polymer. This is intended for inhibiting reduction of the ion conductivity by crystallization of the polymer. As the electrolyte salt, various lithium salts can be used as in a battery having a liquid electrolytic solution. For example, lithium perchlorate (LiClO₄), lithium hexafluorophosphate (LiPF₆), lithium bis(trifluoromethanesulfonyl)imide (LiN(CF₃SO₂)₂, hereinafter abbreviated as LiTFSI) can be used.

The polymer solid electrolyte 14 may contain a plasticizer. When the polymer solid electrolyte 14 contains a plasticizer, ion conductivity is improved. However, since the strength of the polymer solid electrolyte is reduced by addition of a plasticizer, the content of the plasticizer in the polymer solid electrolyte is preferably 10% by weight or less, more preferably 5% by weight or less. It is especially preferable that the polymer solid electrolyte does not contain a plasticizer. As the plasticizer, a well-known material such as a carbonic acid ester such as ethylene carbonate (EC) or ethyl methyl carbonate (EMC), or mixture thereof can be used.

The separator layer 15 contains inorganic solid electrolyte particles 16 and the polymer solid electrolyte 14 filling gaps between the particles. Preferably, inorganic solid electrolyte particles are not exposed to the surface of the separator layer, and the entire surface of the separator layer is thinly covered with the polymer solid electrolyte. This is because a more favorable bonding state can be obtained at the time of bonding two electrode sheets during manufacturing of a battery.

For the inorganic solid electrolyte 16, particles of La_{2/3-x}Li₃ₓTiO₃ (LLT), Li₁₊ₓAl_{y}Ti_{2-y}(PO₄)₃ (LATP), Li₁₊ₓAl_{y}Ge_{2-y}(PO₄)₃ (LAGP) or the like which have a high lithium ion conductivity can be used. Preferably, LAGP is used. This is because LAGP has a stable structure, and hardly reacts even when coming into contact with other materials at the time of forming a paste during manufacturing of an electrode sheet.

The particle size of the inorganic solid electrolyte particles 16 is preferably 0.1 μm to 1 μm. When the particle size is excessively small, dispersibility at the time of paste processing is deteriorated, and aggregation easily occurs, leading to formation of large particles. When the particle size is excessively large, the flatness of the surface of the separator layer 15 is deteriorated, and the ratio of the polymer solid electrolyte 14 having a low lithium ion mobility to the separator layer easily increases, leading to impairment of the mobility of lithium ions passing through the separator layer.

The polymer solid electrolyte 14 contained in the separator layer 15 is the same as the polymer solid electrolyte contained in the electrode 12. Preferably, the polymer solid electrolyte 14 in the electrode 12 and the polymer solid electrolyte 14 in the separator layer 15 are integrally formed. The term “integrally formed” means that the layers are simultaneously formed from one raw material solution by curing the solution rather than being cured separately. In this case, the polymer solid electrolyte 14 continuously extends from the electrode to the separator layer without dividing the skeleton of the polymer. This ensures that interface resistance between the electrode and the separator layer can be further reduced.

The preferred range of the thickness of the separator layer 15 varies depending on a method for manufacturing an all-solid battery as described later. The average thickness of the separator layer of the manufactured battery is preferably 20 μm or less, more preferably 10 μm or less, especially preferably 6 μm or less. When the separator layer is excessively thick, internal resistance of the battery increases. Even when the separator layer is thin, a short-circuit hardly occurs due to the presence of the inorganic solid electrolyte particles 16 having a high strength and hardness. On the other hand, the thickness of the thinnest part of the separator layer of the battery is preferably 1 μm or more, more preferably 2 μm or more. When the separator layer is excessively thin, breakage easily occurs, and it becomes difficult to manufacture the separate layer.

When the positive electrode sheet of this embodiment and the negative electrode sheet of this embodiment are bonded to each other to manufacture a battery (battery of third embodiment), i.e. when both positive and negative electrode sheets each have a separator layer, the average thickness of the separator layer 15 of each electrode sheet is preferably 10 μm or less, more preferably 5 μm or less, especially preferably 3 μm or less, and the thickness of the thinnest part is preferably 0.5 μm or more, more preferably 1 μm or more.

When the positive electrode sheet or the negative electrode sheet of this embodiment and another electrode sheet having no separator layer are bonded to each other to manufacture a battery (battery of fourth embodiment), the average thickness of the separator layer 15 of the electrode sheet of this embodiment is preferably 20 μm or less, more preferably 10 μm or less, especially preferably 6 μm or less, and the thickness of the thinnest part is preferably 1 μm or more, more preferably 2 μm or more.

The thickness of the entire electrode sheet 10 is preferably 50 μm or less, more preferably 40 μm or less. The electrode sheet of this embodiment is particularly suitable for manufacturing a film-shaped thin battery.

A method for manufacturing the electrode sheet 10 will now be described.

Referring to FIG. 2, the method for manufacturing electrode sheet according to this embodiment includes:

(S10) a step of preparing the current collector 11;

(S20) a step of forming an active material layer on the current collector;

(S30) a step of forming an inorganic solid electrolyte layer on the active material layer;

(S40) a solution supplying step of supplying a polymer solid electrolyte solution to the surface of the inorganic solid electrolyte layer to infiltrate the polymer solid electrolyte solution into the active material layer and the inorganic solid electrolyte layer; and

(S50) a curing step of polymerizing the polymer compound.

Step S20 of forming an active material layer is carried out by applying an electrode composite containing active material particles 13 onto the current collector 11.

The electrode composite is formed into a paste by adding the above-mentioned conductive additive, binder, filler and the like to the active material particles 13 as necessary, and adding an appropriate amount of solvent. As the solvent, a well-known organic solvent such as N-methyl-2-pyrrolidone (NMP) can be used.

The method for applying the electrode composite is not particularly limited. The electrode composite can be applied by a die coating method, a comma coating method, a screen printing method or the like. Preferably, a screen printing method is used. This is because the electrode composite can be applied even over a large area with a uniform thickness while an increase in cost is suppressed. When the electrode composite is applied onto the current collector 11, the surface of the current collector may be coated with a primer (undercoat) in order to improve adhesion of the surface of the current collector with the active material particles. After the electrode composite is applied onto the current collector 11, drying is performed to remove the solvent, whereby an active material layer is formed. The active material layer may be compressed by pressing after the drying.

Step S30 of forming an inorganic solid electrolyte layer is carried out by applying an electrolyte composite containing the inorganic solid electrolyte particles 16 onto the active material layer.

The electrolyte composite is formed into a paste by adding a binder, a filler and the like to the inorganic solid electrolyte particles 16 as necessary, and adding an appropriate amount of solvent. As the binder, a known material such as PVdF can be used. As the solvent, a well-known organic solvent such as NMP can be used. Preferably, LAGP is used as the inorganic solid electrolyte, and PVdF is used as the binder. LAGP and PVdF each have favorable performance, and combination of LAGP and PVdF ensures that PVdF does not react with an alkali salt to turn into a gel. It is also preferable to use an ion-conductive binder. This is because the mobility of lithium ions in the electrode is improved.

The method for applying the electrolyte composite is not particularly limited. The electrolyte composite can be applied by a die coating method, a comma coating method, a screen printing method, or a noncontact coating method such as a spray coating method or an inkjet method. Preferably, a screen printing method is used. This is because the electrode composite can be applied even over a large area with a uniform thickness while an increase in cost is suppressed. After the electrolyte composite is applied onto the active material layer, drying is performed to remove the solvent, whereby an inorganic solid electrolyte layer is formed.

Solution supplying step S40 is carried out by supplying a polymer solid electrolyte solution onto the inorganic solid electrolyte layer to infiltrate the polymer solid electrolyte solution into the active material layer and the inorganic solid electrolyte layer, the polymer solid electrolyte solution containing a polymer compound and a lithium salt.

The polymer solid electrolyte solution contains a lithium salt, and a polymer compound that forms a skeleton of the polymer solid electrolyte 14 after polymerization. The polymer solid electrolyte solution contains a crosslinking agent and a polymerization initiator as necessary, and is diluted with an organic solvent so as to have a proper viscosity. The above-mentioned PEO or the like can be used as the polymer compound. As the lithium salt, a material such as the LiTFSI can be used. As a diluting solvent, a low-boiling-point organic solvent such as tetrahydrofuran (THF) or acetonitrile can be suitably used. By using a solution containing the polymer compound before polymerization as described above, gaps between active material particles are easily filled with the polymer solid electrolyte solution. The viscosity of the polymer solid electrolyte solution is preferably 1 to 100 mPa·s, more preferably 5 to 10 mPa·s. When the viscosity is excessively high, it is difficult to infiltrate the solution into the active material layer and the inorganic solid electrolyte layer. Further, when the viscosity is excessively low, the content of the polymer compound decreases, so that economic efficiency is deteriorated, and the density of the polymer solid electrolyte in the inorganic solid electrolyte layer decreases, so that sufficient ion conductivity cannot be maintained.

The method for supplying a polymer solid electrolyte solution is not particularly limited, but a noncontact coating method is preferable. The noncontact coating method is a method in which a solution is supplied without bringing an inorganic solid electrolyte layer into contact with a roll for transferring the solution or a nozzle for discharging the solution. Examples of the noncontact coating method include a spraying method, a dispenser method using pneumatic pressure or an electrostatic force, and various inkjet methods such as a piezo method. In particular, it is preferable to use a dispenser method using an electrostatic force or an inkjet method. This is because even when a low-viscosity solution is supplied, voids of the active material layer and the inorganic solid electrolyte layer are entirely filled with the polymer solid electrolyte solution because of excellent quantitative performance and surface uniformity of the supply amount, and a thin film of the polymer solid electrolyte solution can be formed on the surface of the inorganic solid electrolyte layer.

The solvent of the polymer solid electrolyte solution is evaporated to perform drying, the polymer compound is polymerized in curing step S50 to form the polymer solid electrolyte 14 in gaps between the active material particles 13 in the active material layer and in gaps between the inorganic solid electrolyte particles 16 in the inorganic solid electrolyte. In this way, the electrode 12 containing the active material particles 13 and the polymer solid electrolyte 14 filling gaps between the particles, and the separator layer 15 containing the inorganic solid electrolyte particles 16 and the polymer solid electrolyte 14 filling gaps between the particles are completed. The polymer compound is polymerized by one of thermal curing, ultraviolet ray irradiation and electron beam irradiation, or a combination thereof. Preferably, the polymer compound is polymerized by ultraviolet ray irradiation. This is because manufacturing equipment can be simplified.

The solution supplying step may be carried out in a plurality of divided steps. For example, as shown in FIG. 16, step S41 of supplying a polymer solid electrolyte solution onto the active material layer to infiltrate the polymer solid electrolyte solution into the active material layer may be provided after step S20 of forming the active material layer, and step S42 of supplying a polymer solid electrolyte solution onto the inorganic solid electrolyte layer to infiltrate the polymer solid electrolyte solution into the inorganic solid electrolyte layer may be provided after step S30 of forming the inorganic solid electrolyte layer. Even when the solution supplying step is carried out in two divided steps, the polymer solid electrolyte 14 contained in the electrode 12 and the polymer solid electrolyte 14 contained in the separator layer 15 are integrally formed. Further, by separately supplying the polymer solid electrolyte solution in the active material layer and the polymer solid electrolyte in the inorganic solid electrolyte layer in divided steps, the viscosity of the polymer solid electrolyte solution supplied to each layer and the infiltration property of the polymer solid electrolyte solution into the layer can be optimized, so that it is easy to improve bondability at a solid-solid interface in each layer, and to reliably infiltrate the polymer solid electrolyte solution to the bottom surface in the active material layer.

The effects of the electrode sheet 10 of this embodiment will be described again below.

In the electrode sheet, a polymer solid electrolyte is used rather than a liquid electrolytic solution and a polymer gel-like electrolyte, and therefore there is no risk of liquid leakage. Further, the present inventor has paid attention to the fact that even when a polymer solid electrolyte is used, charge-discharge characteristics close to those of a battery containing an electrolytic solution or a polymer gel-like electrolyte can be obtained as long as the effective thickness of the polymer solid electrolyte is sufficiently small. By diluting the polymer solid electrolyte with a solvent, gaps between particles in an electrode layer including active material particles and the surface layer thereof can be covered with a very thin electrolyte. On the other hand, when a polymer solid electrolyte is formed with such a small thickness, it is not possible to obtain penetration resistance to lithium dendrite or the like and strength required for a separate layer between the positive electrode and the negative electrode. But in recent years, a variety of inorganic solid electrolytes having ion conductivity higher than that of the polymer solid electrolyte have been developed, and it has become possible to secure the insulation quality and strength of the separator layer by using the polymer solid electrolyte and the inorganic solid electrolyte in combination for the separator layer.

Further, gaps between particles cannot be impregnated with a polymer solid electrolyte after completion of polymerization, but according to the method for manufacturing an electrode sheet according to this embodiment, a polymer solid electrolyte solution having a low viscosity is infiltrated into gaps between the active material particles 13 fixed with a binder, and gaps between the inorganic solid electrolyte particles 16, and then polymerized to form a polymer solid electrolyte. Therefore, it is easy to fill gaps between active material particles and gaps between inorganic solid electrolyte particles with the polymer solid electrolyte solution, and it is easy to extensively form the polymer solid electrolyte in the electrode 12 and the separator layer 15 so as to fill very small gaps between particles. Consequently, a battery having a polymer solid electrolyte in a favorable state of contact with active material particles and having low internal resistance can be obtained. Further, since the polymer solid electrolyte in the electrode is formed integrally with the polymer solid electrolyte in the separator layer, a battery having reduced interface resistance and low internal resistance can be obtained.

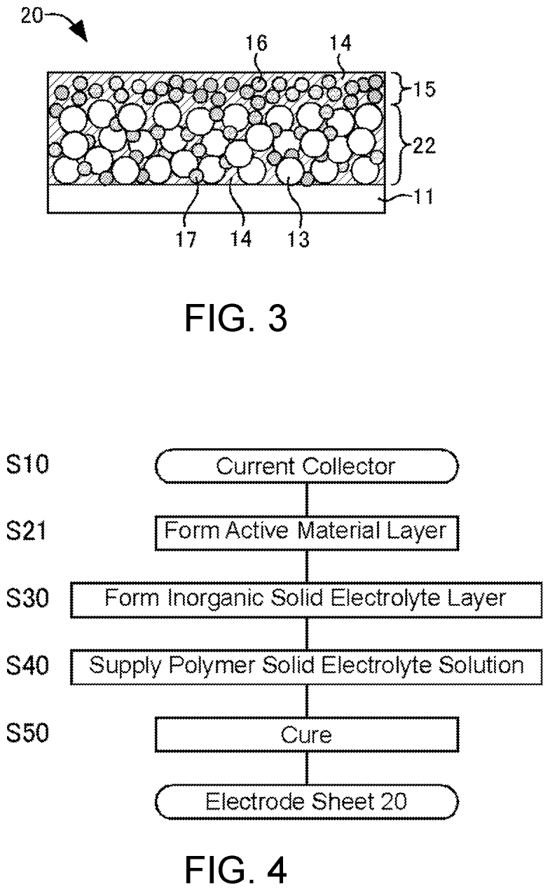

As a second embodiment of the present invention, another electrode sheet for an all-solid lithium ion battery will now be described with reference to FIGS. 3 and 4. The electrode sheet of this embodiment is different from that of the first embodiment in that the electrode contains second inorganic solid electrolyte particles.

In FIG. 3, an electrode sheet 20 of this embodiment is formed by laminating a current collector 11, an electrode 22 and a separator layer 15 in this order. The electrode 22 contains active material particles 13, second inorganic solid electrolyte particles 17, and a polymer solid electrolyte 14 filling gaps between the active material particles and the second inorganic solid electrolyte particles.

The same configurations and materials as in the first embodiment can be used for the current collector 11, the active material particles 13, the polymer solid electrolyte 14, the separator layer 15 and the inorganic solid electrolyte 16. In the second inorganic solid electrolyte 17 contained in the electrode 22, particles of LLT, LATP, LAGP or the like can be used as in the inorganic solid electrolyte 16 contained in the separator layer 15. Preferably, the same compound is used for the second inorganic solid electrolyte 17 and the inorganic solid electrolyte 16.

In FIG. 4, the method for manufacturing the electrode sheet 20 according to this embodiment is different from the method according to the first embodiment in that the second inorganic solid electrolyte particles 17 are blended in an electrode composite to be applied in step S21 of forming an active material layer.

In this embodiment, the second inorganic solid electrolyte particles 17 are present, and thus the mobility of lithium ions in the electrode is further improved as compared to the first embodiment.

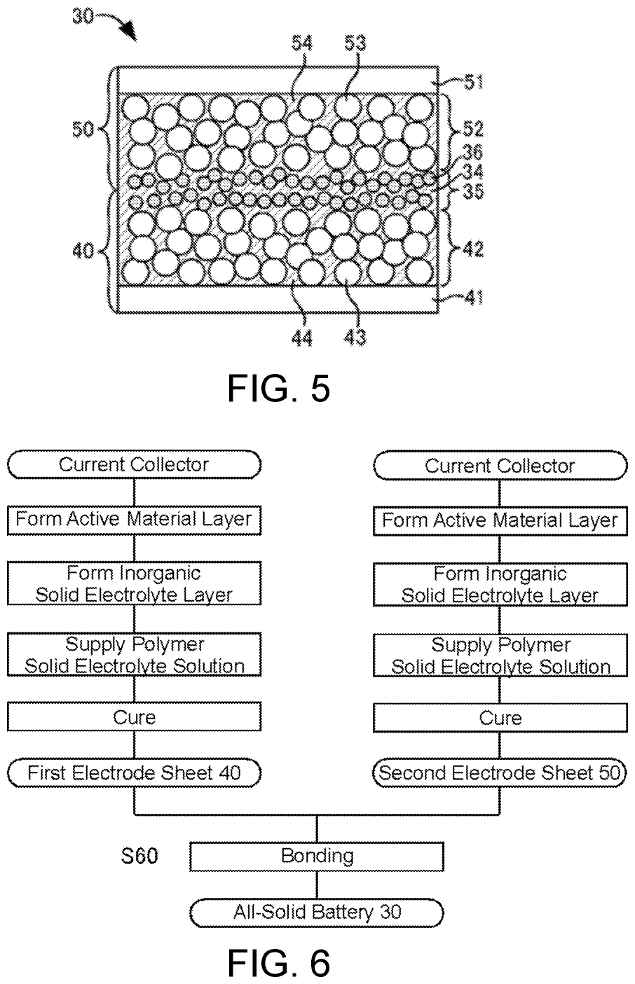

As a third embodiment of the present invention, an all-solid lithium ion battery will now be described with reference to FIGS. 5 and 6.

In FIG. 5, an all-solid battery 30 of this embodiment includes a positive electrode current collector 41, a positive electrode 42, a separator layer 35, a negative electrode 52 and a negative electrode current collector 51. The positive electrode 42 contains positive active material particles 43 and a positive electrode polymer solid electrolyte 44 filling gaps between the positive active material particles. The separator layer 35 contains inorganic solid electrolyte particles 36 and a separator layer polymer solid electrolyte 34 filling gaps between the inorganic solid electrolyte particles 36. The negative electrode 52 contains negative active material particles 53 and a negative electrode polymer solid electrolyte 54 filling gaps between the negative active material particles.

The all-solid battery 30 is a laminate of a positive electrode sheet 40 and a negative electrode sheet 50. Both the positive electrode sheet 40 and the negative electrode sheet 50 are the electrode sheets of the first embodiment. As members which form the positive electrode sheet and the negative electrode sheet, those described for the electrode sheet 10 of the first embodiment can be used. Preferably, the same material is used for the positive electrode polymer solid electrolyte 44, the separator layer polymer solid electrolyte 34 and the negative electrode polymer solid electrolyte 54.

The thickness of the all-solid battery 30 is preferably 100 μm or less, more preferably 80 μm or less. The configuration of the electrode sheet of each of the above-described embodiments exhibits a particularly remarkable effect when used for such a thin battery. In use of the all-solid battery 30, the peripheral edge portion may be sealed with a hot melt material or the like with the whole body sandwiched by an exterior material.

In FIG. 6, a method for manufacturing the all-solid battery 30 according to this embodiment includes: a step of manufacturing as a first electrode sheet the positive electrode sheet 40 which is the electrode sheet of the first embodiment; a step of manufacturing as a second electrode sheet the negative electrode sheet 50 which is the electrode sheet of the first embodiment; and bonding step S60 of bonding the positive electrode sheet and the negative electrode sheet to each other.

In bonding step S60, the positive electrode sheet 40 and the negative electrode sheet 50 are bonded to each other in such a manner that the separator layers of the electrode sheets are in contact with each other, i.e. the current collectors 41 and 51 of the electrode sheets form the outermost surface. Consequently, the separator layer of the positive electrode sheet and the separator layer of the negative electrode sheet are combined to form the separator layer 35 of the all-solid battery 30. The positive electrode polymer solid electrolyte 44 is formed integrally with a portion of the separator layer polymer solid electrolyte 34 which is in contact with the positive electrode 42, and the negative electrode polymer solid electrolyte 54 is formed integrally with a portion of the separator layer polymer solid electrolyte 34 which is in contact with the negative electrode 52.

Preferably, one or both of the separator layers of the positive electrode sheet 40 and the negative electrode sheet 50 is softened with a plasticizer at a surface layer, e.g. an area of 1 μm or less from the surface of the separator layer, followed by bonding the positive electrode sheet and the negative electrode sheet to each other. This ensures that the bonding state between the separator layer of the positive electrode sheet and the separator layer of the negative electrode sheet is improved to reduce the internal resistance of the battery. As the plasticizer, an organic solvent such as ethylene carbonate (EC), propylene carbonate (PC), ethyl methyl carbonate (EMC) or a mixture thereof can be used.

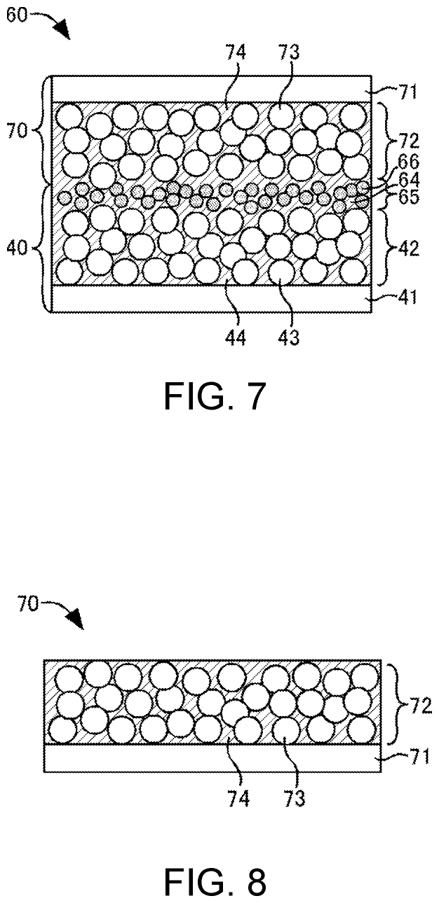

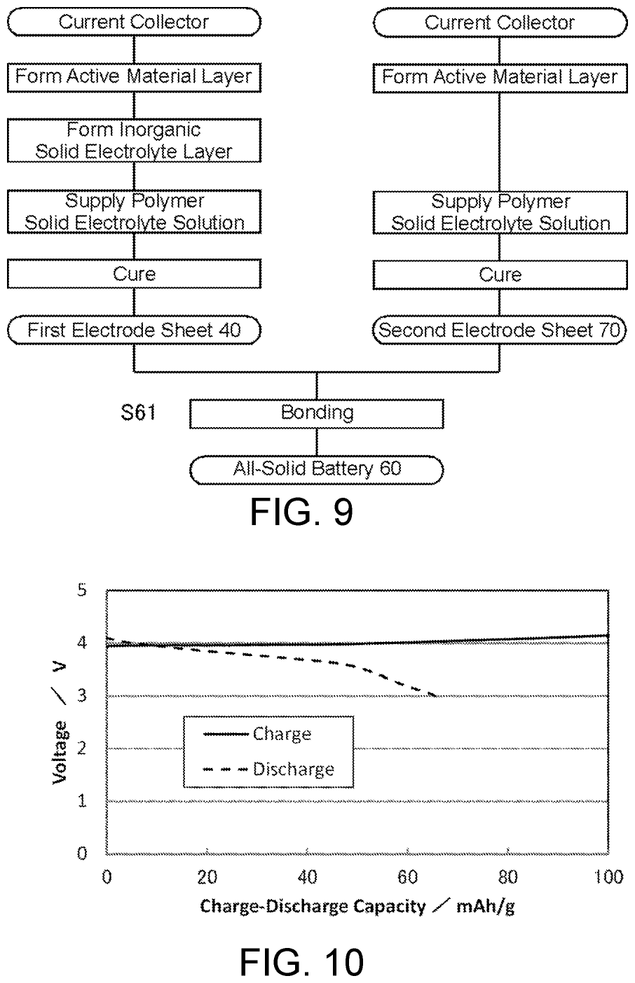

As a fourth embodiment of the present invention, an all-solid lithium ion battery will now be described with reference to FIGS. 7 and 9.

In FIG. 7, an all-solid battery 60 of this embodiment includes a positive electrode current collector 41, a positive electrode 42, a separator layer 65, a negative electrode 72 and a negative electrode current collector 71, and has the same structure as that of the all-solid battery 30 of the third embodiment. However, the method for manufacturing the all-solid battery 60 is different from that in the third embodiment.

The all-solid battery 60 is a laminate of a positive electrode sheet 40 and a negative electrode sheet 70. The positive electrode sheet 40 is the electrode sheet of the first embodiment. As members which form the positive electrode sheet, those described for the electrode sheet 10 of the first embodiment can be used.

In FIG. 8, the negative electrode sheet 70 includes a negative electrode current collector 71 and a negative electrode 72, and has no separator layer. The same configurations and materials as in the first embodiment can be used for the negative electrode current collector 71, the negative electrode 72, negative active material particles 73 and a negative electrode polymer solid electrolyte 74.

In FIG. 9, a method for manufacturing the all-solid battery 60 according to this embodiment includes: a step of manufacturing as a first electrode sheet the positive electrode sheet 40 which is the electrode sheet of the first embodiment; a step of manufacturing as a second electrode sheet the negative electrode sheet 70 having no separator layer; and second bonding step S61 of bonding the positive electrode sheet and the negative electrode sheet to each other.

A method for manufacturing the negative electrode sheet 70 includes: a step of preparing a negative electrode current collector 71; a step of forming a negative active material layer on the negative electrode current collector by applying a negative electrode composite containing negative active material particles 73; a step of supplying a second polymer solid electrolyte solution onto the negative active material layer to infiltrate the second polymer solid electrolyte solution into the negative active material layer, the second polymer solid electrolyte solution containing a second polymer compound and a lithium salt; and a curing step of completing the negative electrode 72 by polymerizing the second polymer compound to form the negative electrode polymer solid electrolyte 74 between negative active material particles in the negative active material layer.

In second bonding step S61, the positive electrode sheet 40 and the negative electrode sheet 70 are bonded to each other in such a manner that the separator layer of the positive electrode sheet and the negative electrode 72 of the negative electrode sheet are in contact with each other, i.e. the current collectors 41 and 71 of the electrode sheets form the outermost surface. In this manufacturing method, the separator layer of the positive electrode sheet forms the separator layer 65 of the all-solid battery 60. The positive electrode polymer solid electrolyte 44 is formed integrally with a portion of the separator layer polymer solid electrolyte 64 which is in contact with the positive electrode 42.

In this manufacturing method, the negative electrode sheet which is the electrode sheet of the first embodiment may be manufactured as the first electrode sheet, and the positive electrode sheet having no separator layer may be used as the second electrode sheet.

### EXAMPLES

First, the inventor found that by forming a polymer solid electrolyte between inorganic solid electrolyte particles in a separator layer in accordance with the following method, lithium ion conductivity was effectively developed between the inorganic solid electrolyte particles. That is, an inorganic solid electrolyte layer with polyvinylidene fluoride (PvDF) as a binder was formed on an aluminum foil, a polymer solid electrolyte solution was then infiltrated into the inorganic solid electrolyte layer, an aluminum foil counter electrode was contiguously disposed on the layer, and a polymer in the polymer solid electrolyte solution was then crosslinked and cured by polymerization reaction to form an all-solid electrolyte layer having a polymer solid electrolyte infiltrated between inorganic solid electrolyte particles. The ion conductivity of the all-solid electrolyte layer was evaluated. Here, Li₁₊ₓAl_{y}Ge_{2-y}(PO₄)₃ (LAGP) having a particle size of about 1 μm was used for the inorganic solid electrolyte particles. The polymer solid electrolyte solution contained a polymer compound forming a skeleton of the polymer solid electrolyte after polymerization, a lithium salt, a crosslinking agent and a polymerization initiator, and was diluted with an organic solvent so as to have a proper viscosity.

The lithium ion conductivity of the obtained all-solid electrolyte layer at room temperature was measured using an alternating current impedance method. The ion conductivity σ was calculated from the following expression.

σ=L/(R×S)

In the expression, σ is an ion conductivity (unit: S/cm), L is an interelectrode distance (unit: cm), R is a resistance (unit: Ω) calculated from a real impedance intercept of Cole-Cole plot, and S is a sample area (unit: cm²). The results are shown in Table 1.

TABLE 1

| | | Layer including |
|---|---|---|
| | | inorganic solid |
| | Layer including | electrolyte |
| | only inorganic | particles and |
| | solid electrolyte | polymer solid |
| Ion conductivity σ | particles | electrolyte |
| Unit: S/cm | 2.0 × 10⁻⁷ | 2.7 × 10⁻⁵ |
| Unit: S/5 μm | 4.0 × 10⁻⁴ | 5.4 × 10⁻² |

In Table 1, the ion conductivity of the inorganic solid electrolyte layer before application of the polymer solid electrolyte solution was 2.0×10⁻⁷ S/cm, whereas the ion conductivity of the all-solid electrolyte layer obtained by performing polymerization and curing after impregnation with the polymer solid electrolyte solution was 2.7×10⁻⁵ S/cm. A value calculated in terms of an ion conductivity where the thickness of the all-solid electrolyte layer is 5 μm is 5.4×10⁻²S/5 μm. Thus, it was confirmed that even when an all-solid electrolyte layer having no electrolytic solution was used, favorable lithium ion conductivity was developed by filling gaps between particles in the inorganic solid electrolyte with a polymer solid electrolyte. The ion conductivity of the single polymer solid electrolyte used here at this time was 6.4×10⁻⁵ S/cm.

As Comparative Example 1, a positive electrode sheet of a lithium ion battery was produced in the following manner. A positive electrode composite was prepared in the following manner: lithium cobaltate (LiCoO₂, Toshima Manufacturing Co., Ltd., grade: LiCoO₂ fine powder, average particle diameter: 1 μm) as an active material, ketjen black (KB) as a conductive additive and polyvinylidene fluoride (PVdF) as a binder were mixed at a weight ratio of 95:2:3, and the mixture was formed into a paste by adding N-methyl-2-pyrrolidone (NMP) in such a manner that the solid content ratio was 52% by weight. The positive electrode composite paste was applied in a size of 50 mm×50 mm onto a 20 μm-thick aluminum foil by screen printing, and dried at 80° C. to 120° C. for 2 hours to form a positive active material layer having a thickness of 15 μm. A polymer solid electrolyte solution was prepared by mixing a photopolymerization initiator and LiTFS as a lithium salt with polyethylene oxide (PEO) as a polymer compound, and adding NMP as a solvent to adjust the viscosity. The solution was supplied to the surface of the positive active material layer by an inkjet method to fill the positive active material layer entirely, and the polymer compound was then crosslinked by applying an ultraviolet ray. Consequently, a polymer solid electrolyte phase was formed between positive active material particles, and a polymer solid electrolyte layer having a thickness of 5 μm was formed on the positive active material layer.

Using the positive electrode sheet, an evaluation battery was produced in the following manner, and a charge-discharge test was conducted. The positive electrode sheet was cut to a size of 10 mm×10 mm, and laminated to a lithium metal foil to produce an evaluation battery. Here, a 25 μm-thick porous film (material: polypropylene) impregnated with a nonaqueous electrolytic solution (1 mol/L LiPF₆, EC:EMC=3:7) in a minimum required amount was used as a separator film. As conditions for the charge-discharge test, constant current-constant voltage charge was performed at a current of 20 μA and a voltage of 4.3 V for 10 hours, and constant current discharge was performed at a current of 20 μA and a termination voltage of 3.0 V. The results are shown in FIG. 10.

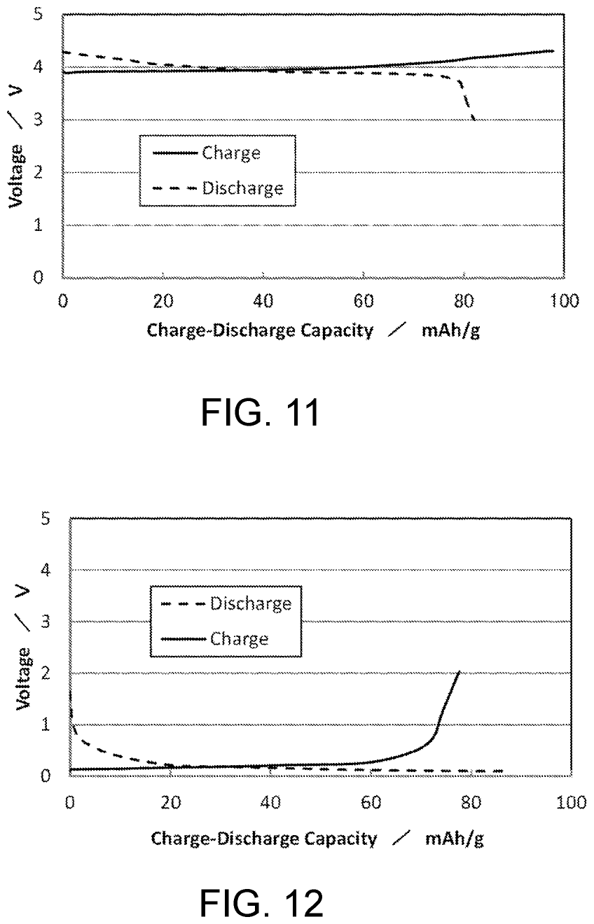

As Comparative Example 2, an evaluation battery was produced in the following manner: a positive active material layer was formed on an aluminum foil as in Comparative Example 1, and laminated to a lithium metal foil with a nonaqueous electrolytic solution-containing separator film interposed therebetween while a polymer solid electrolyte solution was not applied. The size of the positive electrode sheet of this evaluation battery is 10 mm×10 mm as in Comparative Example 1. The results are shown in FIG. 11.

Comparison between FIG. 10 and FIG. 11 shows that the battery capacity was higher in Comparative Example 2 in which a normal nonaqueous electrolytic solution was used. It was confirmed that nevertheless, the positive electrode sheet of Comparative Example 1 in which gaps between positive active material particles were filled with the polymer solid electrolyte had favorable lithium ion conductivity.

As Comparative Example 3, a negative electrode sheet of a lithium ion battery was produced in the following manner. A negative electrode composite was prepared in the following manner: artificial graphite (Showa Denko K.K., grade: SCMG, average particle diameter: 5 μm) as an active material, KB as a conductive additive and PVdF as a binder were mixed at a weight ratio of 96:1:3, and the mixture was formed into a paste by adding NMP in such a manner that the solid content ratio was 50% by weight. The negative electrode composite paste was applied in a size of 50 mm×50 mm onto a 15 μm-thick copper foil by screen printing, and dried at 80° C. to 120° C. for 2 hours to form a negative active material layer having a thickness of 15 μm. The same polymer solid electrolyte solution as in Comparative Example 1 was supplied to the surface of the negative active material layer by an inkjet method to fill the negative active material layer entirely, and the polymer compound was then crosslinked by applying an ultraviolet ray. Consequently, a polymer solid electrolyte phase was formed between negative active material particles, and a polymer solid electrolyte layer having a thickness of 5 μm was formed on the negative active material layer.

The obtained negative electrode sheet was cut to a size of 10 mm×10 mm, laminated to a lithium metal foil with the same separator film as in Comparative Example 1 interposed therebetween. In this way, an evaluation battery was produced, and subjected to a charge-discharge test under the same conditions as in Comparative Example 1. The results are shown in FIG. 12. The results in FIG. 12 show that the negative electrode sheet of Comparative Example 3 had a structure in which gaps between negative active material particles were filled with a polymer solid electrolyte, but the negative electrode sheet had favorable lithium ion conductivity.

As Example 1, the lithium ion battery positive electrode sheet of the first embodiment was produced in the following manner. A positive electrode composite was prepared in the same manner as in Comparative Example 1. As in Comparative Example 1, the positive electrode composite paste was applied in a size of 50 mm×50 mm onto a 20 μm-thick aluminum foil by screen printing, and dried at 80° C. to 120° C. for 2 hours to form a positive active material layer having a thickness of 15 μm. The electrolyte composite was mixed at a ratio of LAGP:PVdF=97:3 (weight ratio), and NMP was added in such a manner that the solid content ratio was 69% by weight. The electrolyte composite paste was applied in a size of 56 mm×56 mm onto the positive active material layer by screen printing, and dried at 80° C. for 20 hours to form a 10 μm-thick inorganic solid electrolyte layer on the positive active material layer. The same polymer solid electrolyte solution as in Comparative Example 1 was supplied to the surface of the inorganic solid electrolyte layer by an inkjet method, and left standing to fill voids in the positive active material layer and the inorganic solid electrolyte layer entirely, and the polymer compound was then crosslinked by applying an ultraviolet ray. In this way, a separator layer was formed on the positive active material layer. The thickness of the separator layer was 13 μm. That is, a surface layer region of 3 μm did not contain inorganic solid electrolyte particles, and contained only a polymer solid electrolyte.

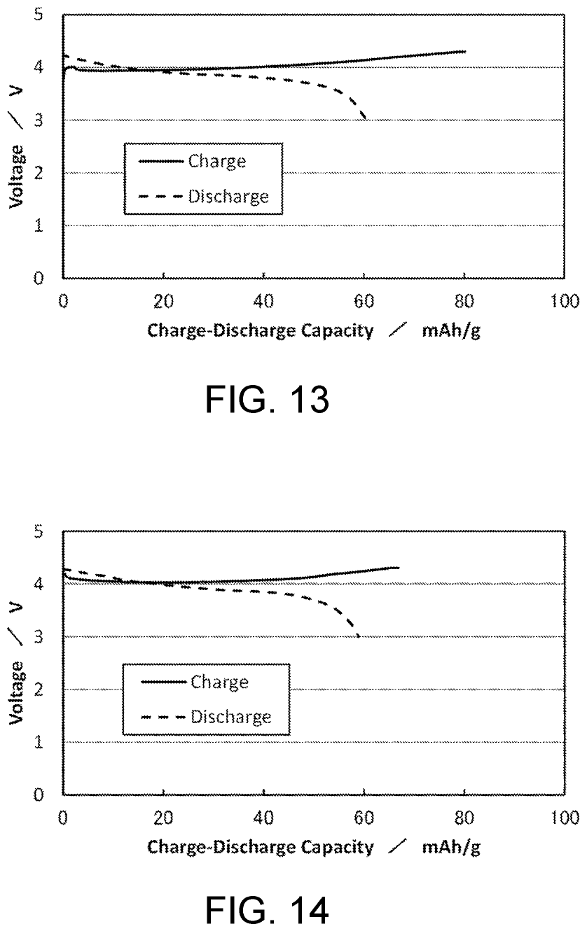

The obtained positive electrode sheet was laminated to a lithium metal foil with a separator film interposed therebetween as in Comparative Example 1. In this way, an evaluation battery was produced, and subjected to a charge-discharge test under the same conditions as in Comparative Example 1. The results are shown in FIG. 13.

As Comparative Example 4, an evaluation battery was produced in the following manner: a positive active material layer and a 10 μm-thick inorganic solid electrolyte layer were formed on an aluminum foil as in Example 1, and laminated to a lithium metal foil with a nonaqueous electrolytic solution-containing separator film interposed therebetween while a polymer solid electrolyte solution was not applied. A charge-discharge test was conducted under the same conditions as in Comparative Example 1. The results are shown in FIG. 14.

Comparison between FIG. 13 and FIG. 14 shows that there was a battery capacity difference depending on whether the electrolyte phase between positive active material particles and inorganic solid electrolyte particles was solid or liquid, but the positive electrode sheet of the first embodiment had favorable lithium ion conductivity.

For the positive electrode composite and/or the electrolyte composite in Example 1, an ion-conductive binder (ICB) can be used in place of PVdF. Here, for example, except that LiCoO₂, KB and ICB are mixed at a weight ratio of LiCoO₂:KB:ICB=95:2:3 for the positive electrode composite, LAGP and ICB are mixed at a weight ratio of LAGP ICB=97:3 for the electrolyte composite, and the mixture is formed into a paste by adding NMP, the same method as in Example 1 can be carried out to produce the lithium ion battery positive electrode sheet of the first embodiment.

As Example 2, the all-solid battery of the fourth embodiment was produced by bonding the positive electrode sheet of Example 1 and the negative electrode sheet of Comparative Example 3 to each other. For preventing the current collector end portions of both electrode sheets from being short-circuited in bonding of the electrode sheets, the size of the negative electrode sheet was set to 50 mm×50 mm, and the size of the positive electrode was set to 56 mm×56 mm in terms of a separator layer containing an inorganic solid electrolyte, so that the negative electrode sheet was fitted in the positive electrode sheet. Further, in bonding of the negative electrode sheet and the positive electrode sheet, a plasticizer was applied to and spread over the surface of the separator layer of the positive electrode sheet, and the positive electrode sheet was then bonded to the negative electrode sheet. This ensures that only the surface layer portions of the completely solidified positive electrode sheet and negative electrode sheet can be dissolved to enhance the bondability of the solid/solid interface.

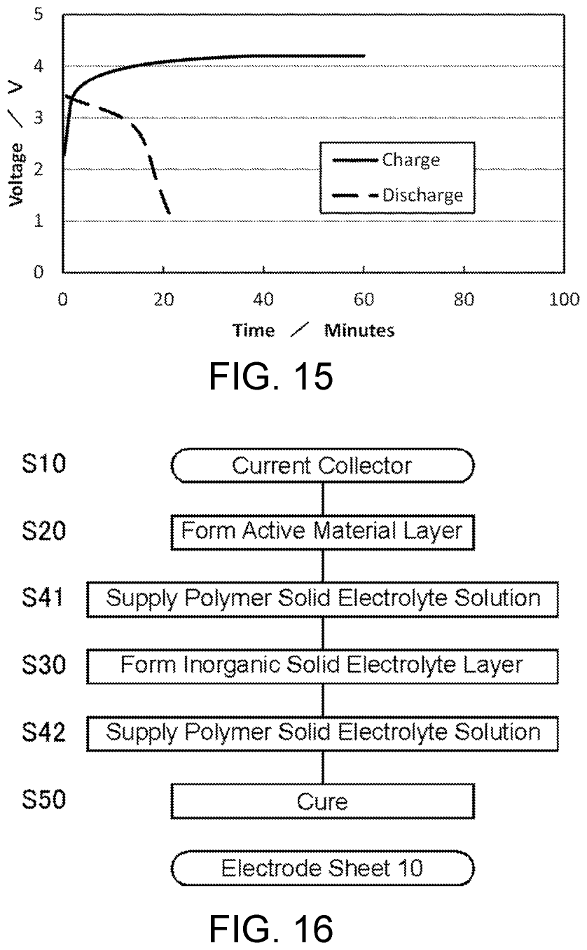

A charge-discharge test was conducted under the following conditions: constant current-constant voltage charge was performed at a current of 100 μA and a voltage of 4.2 V for 60 minutes, and constant current discharge was performed at a current of 100 μA and a termination voltage of 1.0 V. The results of the charge-discharge test are shown in FIG. 15. FIG. 15 reveals that the battery of Example 2 stably performed charge-discharge operations.

A battery of Comparative Example 5 was produced by bonding the positive electrode sheet of Comparative Example 1 and the negative electrode sheet of Comparative Example 3 to each other in the same manner as in Example 2. The positive electrode sheet and the negative electrode sheet each had a 5 μm-thick polymer solid electrolyte layer on the surface. A charge-discharge test was conducted, but the charge voltage did not rise with elapse of time. The cause of this is not evident, but it is considered that some leak current occurred.

The present invention is not limited to the embodiments described above, and various modifications can be made within the scope of the technical idea of the present invention.

### REFERENCE SIGNS LIST

10, 20 electrode sheet
11 current collector
12, 22 electrode
13 active material
14 polymer solid electrolyte
15 separator layer
16 inorganic solid electrolyte
17 second inorganic solid electrolyte
30, 60 all-solid battery
34, 64 separator layer polymer solid electrolyte
35, 65 separator layer
36, 66 inorganic solid electrolyte
40 positive electrode sheet (first electrode sheet)
41 positive electrode current collector
42 positive electrode
43 positive active material
44 positive electrode polymer solid electrolyte
50 negative electrode sheet (second electrode sheet)
51 negative electrode current collector
52 negative electrode
53 negative active material
54 negative electrode polymer solid electrolyte
70 negative electrode sheet (second electrode sheet)
71 negative electrode current collector (second current collector)
72 negative electrode
73 negative active material (second active material)
74 negative electrode polymer solid electrolyte

1. An electrode sheet comprising:
a current collector;
an electrode formed on the current collector and containing active material particles and a polymer solid electrolyte filling gaps between the active material particles; and
a separator layer formed on the electrode and containing inorganic solid electrolyte particles and the polymer solid electrolyte filling gaps between the inorganic solid electrolyte particles.

2. The electrode sheet according to claim 1, wherein the polymer solid electrolyte contained in the electrode and the polymer solid electrolyte contained in the separator layer are integrally formed.

3. The electrode sheet according to claim 1, wherein the electrode further contains second inorganic solid electrolyte particles.

4. An all-solid battery in which
a positive electrode current collector;
a positive electrode containing positive active material particles and a positive electrode polymer solid electrolyte filling gaps between the positive active material particles;
a separator layer containing inorganic solid electrolyte particles and a separator layer polymer solid electrolyte filling gaps between the inorganic solid electrolyte particles;
a negative electrode containing negative active material particles and a negative electrode polymer solid electrolyte filling gaps between the negative active material particles; and
a negative electrode current collector are laminated, in this order.

5. The all-solid battery according to claim 4, wherein at least one of the positive electrode polymer solid electrolyte and the negative electrode polymer solid electrolyte is formed integrally with the separator layer polymer solid electrolyte at a portion which is in contact with the positive electrode polymer solid electrolyte or the negative electrode polymer solid electrolyte.

6. The all-solid battery according to claim 4, wherein at least one of the positive electrode and the negative electrode further contains second inorganic solid electrolyte particles.

7. A method for manufacturing an electrode sheet, the method comprising:
a step of preparing a current collector;
a step of forming an active material layer on the current collector by applying an electrode composite containing active material particles;
a step of forming an inorganic solid electrolyte layer containing inorganic solid electrolyte particles on the active material layer;
a solution supplying step of supplying a polymer solid electrolyte solution to infiltrate the polymer solid electrolyte solution into the active material layer and the inorganic solid electrolyte layer, the polymer solid electrolyte solution containing a polymer compound and an alkali metal salt; and
a curing step of forming a polymer solid electrolyte between the active material particles and between the inorganic solid electrolyte particles by polymerizing the polymer compound after the solution supplying step.

8. The method according to claim 7, wherein the solution supplying step includes the following two steps of:
supplying the polymer solid electrolyte solution onto the active material layer to infiltrate the polymer solid electrolyte solution into the active material layer after forming the active material layer; and
supplying the polymer solid electrolyte solution onto the inorganic solid electrolyte layer to infiltrate the polymer solid electrolyte solution into the inorganic solid electrolyte layer after forming the inorganic solid electrolyte layer.

9. The method according to claim 7, wherein the solution supplying step is a step of supplying the polymer solid electrolyte solution by a noncontact coating method.

10. The method according to claim 7, wherein the electrode composite further contains second inorganic solid electrolyte particles.

11. A method for manufacturing an all-solid battery, the method comprising:
a step of manufacturing a first electrode sheet by the method according to claim 7;
a step of manufacturing a second electrode sheet opposite in polarity to the first electrode sheet by the method according to claim 7; and
a bonding step of bonding the first electrode sheet and the second electrode sheet to each other in such a manner that the current collectors of the electrode sheets form the outermost surface.

12. A method for manufacturing an all-solid battery, the method comprising:
a step of manufacturing a first electrode sheet by the method according to claim 7;
a second electrode sheet manufacturing step of manufacturing a second electrode sheet opposite in polarity to the first electrode sheet, the second electrode sheet manufacturing step including:
a step of preparing a second current collector;
a step of forming a second active material layer containing second active material particles on the second current collector;
a second solution supplying step of supplying a second polymer solid electrolyte solution onto the second active material layer to infiltrate the second polymer solid electrolyte solution into the second active material layer, the second polymer solid electrolyte solution containing a second polymer compound and the alkali metal salt; and
a second curing step of forming a second polymer solid electrolyte between the second active material particles by polymerizing the second polymer compound; and
a second bonding step of bonding the first electrode sheet and the second electrode sheet in such a manner that the current collectors of the electrode sheets form the outermost surface.

13. The method according to claim 8, wherein the solution supplying step is a step of supplying the polymer solid electrolyte solution by a noncontact coating method.

14. The method according to claim 8, wherein the electrode composite further contains second inorganic solid electrolyte particles.

15. A method for manufacturing an all-solid battery, the method comprising:
a step of manufacturing a first electrode sheet by the method according to claim 8;
a step of manufacturing a second electrode sheet opposite in polarity to the first electrode sheet by the method according to claim 8; and
a bonding step of bonding the first electrode sheet and the second electrode sheet to each other in such a manner that the current collectors of the electrode sheets form the outermost surface.

16. A method for manufacturing an all-solid battery, the method comprising:
a step of manufacturing a first electrode sheet by the method according to claim 8;
a second electrode sheet manufacturing step of manufacturing a second electrode sheet opposite in polarity to the first electrode sheet, the second electrode sheet manufacturing step including:
a step of preparing a second current collector;
a step of forming a second active material layer containing second active material particles on the second current collector;
a second solution supplying step of supplying a second polymer solid electrolyte solution onto the second active material layer to infiltrate the second polymer solid electrolyte solution into the second active material layer, the second polymer solid electrolyte solution containing a second polymer compound and the alkali metal salt; and
a second curing step of forming a second polymer solid electrolyte between the second active material particles by polymerizing the second polymer compound; and
a second bonding step of bonding the first electrode sheet and the second electrode sheet in such a manner that the current collectors of the electrode sheets form the outermost surface.
